(19) United States
(12) Patent Application Publication
(10) Pub. No.: US 2010/0299474 A1
(43) Pub. Date: Nov. 25, 2010

(54) INFORMATION PROCESSING APPARATUS, MEDIA DRIVE AND MEDIA DATA CACHING MANAGEMENT METHOD IN INFORMATION PROCESSING APPARATUS

(75) Inventor: Gen WATANABE, Akishima-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/783,398

(22) Filed: May 19, 2010

(30) Foreign Application Priority Data
May 20, 2009 (JP) 2009-122323

(51) Int. Cl. G06F 12/02; G06F 12/08; G06F 1/32; G06F 13/24

(52) U.S. Cl. 711/103; 711/113; 713/321; 710/266; 711/E12.008; 711/E12.019

(57) ABSTRACT

According to one embodiment, an information processing apparatus includes a first caching processing module which starts a caching moving image data stored in a storage medium in a memory device when the storage medium is loaded in a media drive, and a second caching processing module which erases all of moving image data items cached in the memory device when the storage medium is ejected from the media drive.

### CROSS-REFERENCE TO RELATED APPLICATIONS

This application is based upon and claims the benefit of priority from Japanese Patent Application No. 2009-122323, filed May 20, 2009, the entire contents of which are incorporated herein by reference.

### BACKGROUND

1. Field

One embodiment of the invention relates to a data caching processing technique suitably applied for a personal computer that can be powered by battery and includes a function of reproducing audiovisual content recorded on a Digital Versatile Disc (DVD), for example.

2. Description of the Related Art

Recently, various types of personal computers such as desktop and notebook personal computers are widely used. Most of the personal computers of the above types mount optical disc drives (ODDs) that make data access to DVDs and compact discs (CDs), and include functions of reproducing audiovisual content recorded on the DVDs or CDs loaded in the ODDs by use of software.

When audiovisual content recorded on a DVD or CD is read via the ODD, a data caching operation is generally performed so as to smoothly input data in audiovisual content reproduction software. As various control methods for the data caching operation, various methods are proposed so far (for example, see Jpn. Pat. Appln. KOKAI Publication No. 2006-331565).

In the case of a notebook personal computer formed to be powered by battery on the assumption that it is portable, the usability thereof is enhanced by extending the continuous battery-powered time even a little. Therefore, how to attain power saving is important.

In Jpn. Pat. Appln. KOKAI Publication No. 2006-331565, noise is suppressed by optimizing the rotational speed of the ODD by taking the space status of a cache and the power saving can be simultaneously attained by preventing the rotational speed from being kept higher than necessary.

However, a state in which supply of power to the ODD that consumes much electric power (since it includes a mechanism to rotate a DVD or CD) is interrupted is not attained. Therefor, a mechanism for further silencing and power saving is required.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing the appearance of an information processing apparatus according to an embodiment of the invention;

FIG. 2 is an exemplary diagram showing the system configuration relating to reproduction of moving image data stored on a storage medium received in a media drive of the information processing apparatus of the embodiment;

FIG. 3 is an exemplary flowchart showing a caching process when a storage medium on which moving image data is stored is received in a media drive of the information processing apparatus of the embodiment;

FIG. 4 is an exemplary flowchart showing a caching process when a storage medium on which moving image data is stored is ejected from the media drive of the information processing apparatus of the embodiment; and

FIG. 5 is an exemplary diagram showing one configuration example of a media drive including an audiovisual content caching management method of the invention.

### DETAILED DESCRIPTION

Various embodiments according to the invention will be described hereinafter with reference to the accompanying drawings. In general, according to one embodiment of the invention, an information processing apparatus includes a first caching processing module which starts a caching moving image data stored in a storage medium in a memory device when the storage medium is loaded in a media drive, and a second caching processing module which erases all of moving image data items cached in the memory device when the storage medium is ejected from the media drive.

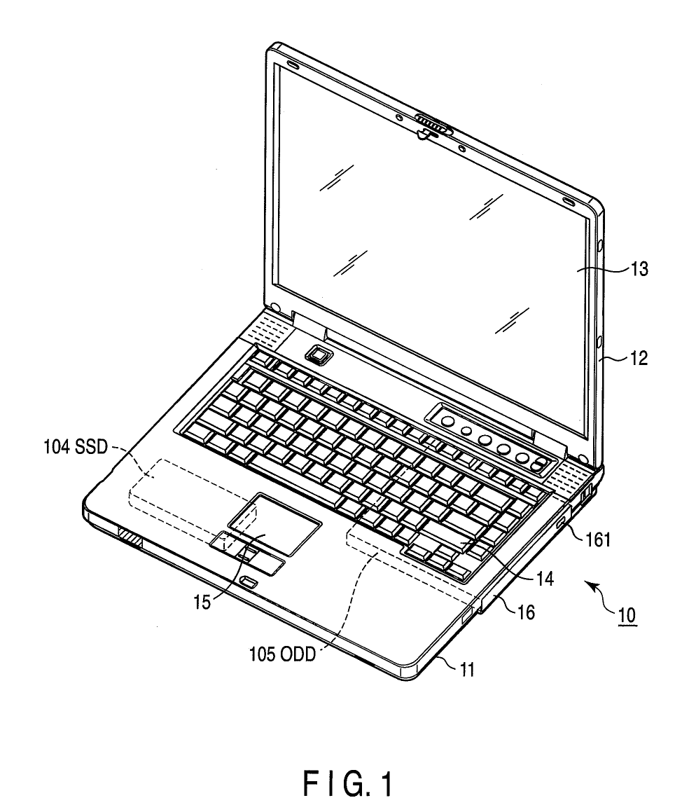

FIG. 1 is an exemplary view showing the appearance of an information processing apparatus according to an embodiment of the invention. The information processing apparatus of the embodiment is realized as a notebook personal computer 10, for example.

As shown in FIG. 1, the computer 10 includes a computer main body 11 and a display unit 12. In the display unit 12, a liquid crystal display (LCD) 13 is incorporated.

The display unit 12 is rotatably mounted on the computer main body 11 between an open position in which the upper surface of the computer main body 11 is exposed and a closed position in which it covers the upper surface of the computer main body 11. The computer main body 11 is a thin-box type casing and a keyboard 14, pointing device 15 and the like are arranged on the upper surface thereof.

The computer main body 11 includes a solid-state drive (SSD) 104 and ODD 105 as external storage apparatuses and a tray ejection port 16 of the ODD 105 is formed on the right-side surface thereof. Further, an ODD eject switch 161 used to eject a tray, that is, load or eject a storage medium such as a DVD or CD is arranged on the side surface of the tray exposed from the tray ejection port 16.

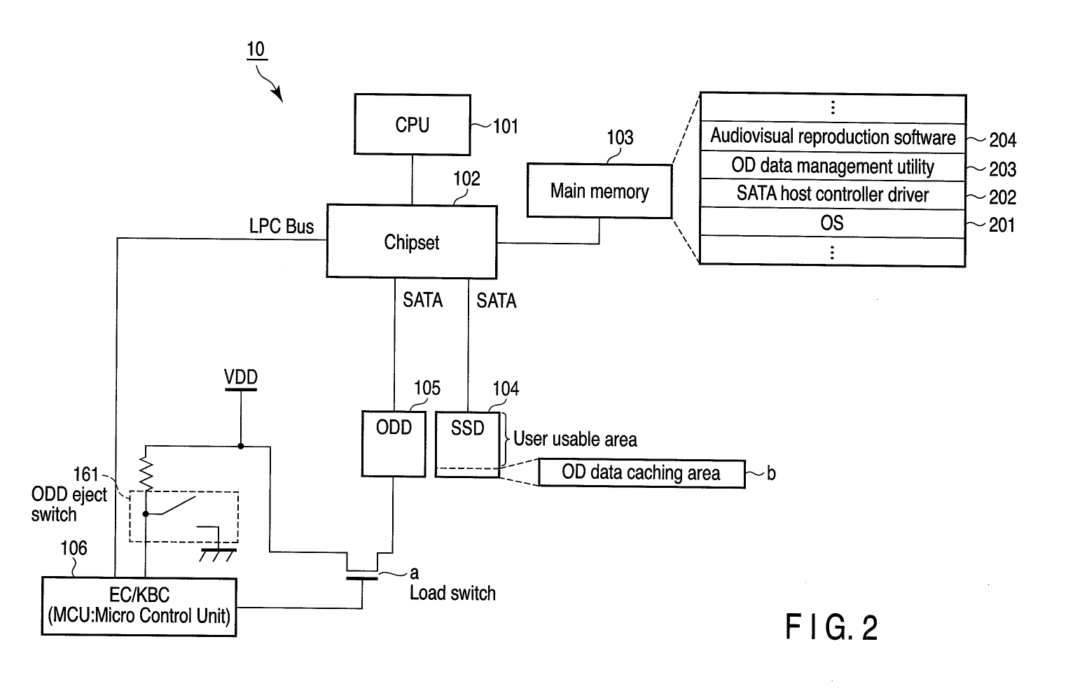

FIG. 2 is an exemplary diagram showing the system configuration of the computer 10 relating to reproduction of audiovisual content stored on a storage medium received in the ODD 105.

As shown in FIG. 2, the computer 10 includes a CPU 101, a chipset 102, a main memory 103, an SSD 104, an ODD 105, an embedded controller/keyboard controller (EC/KBC) 106 and the like.

The CPU 101 is a processor for controlling the operation of the computer 10 and executes an operating system (OS) 201 loaded from the SSD 104 to the main memory 103 and various programs operated under the OS 201. As the various programs, for example, a SATA (serial AT attachment) host controller driver 202, an OD data management utility 203 and an audiovisual reproduction software 204 that will be described later are provided.

The chipset 102 is a controller that controls the main memory 103, the SSD 104 and the ODD 105 and includes a memory controller that controls access to the main memory 103 and a SATA host controller that controls accesses to the SSD 104 and the ODD 105.

The main memory 103 is a storage apparatus used as a main memory of the computer 10 and the SSD 104 and the ODD 105 are storage apparatuses used as auxiliary memories of the computer 10. The computer 10 includes the SSD 104 mounted thereon instead of a hard disk drive (HDD) that is generally used so far as a bootable disk to attain silencing and power saving. Further, the computer 10 is provided with a caching management method of audiovisual content that realizes silencing and power saving when reproducing the audiovisual content on a storage medium received in the ODD 105. Next, the caching management method of audiovisual content is explained in detail.

The EC/KBC 106 is a one-chip micro control unit (MCU) in which a built-in controller used for power management and a keyboard controller used to control the keyboard 14 and pointing device 15 are integrated. The EC/KBC 106 is connected to the chipset 102 via a low pin count (LPC) bus and includes a function of detecting that the ODD eject switch 161 is operated and a function of controlling the switching operation of power supply/interruption with respect to the ODD 105 by means of a load switch “a”.

First, the operation of the computer 10 when the user loads a storage medium on which audiovisual content is stored into the ODD 105 is explained.

When the ODD eject switch 161 is operated (to load a storage medium into the ODD 105), the EC/KBC 106 detects this operation. The EC/KBC 106 that has detected the operation of the ODD eject switch 161 first asserts an ODD power-on signal to the load switch “a” to start supply of power to the ODD 105. Then, the EC/KBC 106 notifies power-on of the ODD 105 to the chipset 102 via the LPC bus.

The chipset 102 that has received the above notification supplies a CPU interrupt signal to the CPU 101, for example, to notify that the ODD eject switch 161 has been operated with respect to the OD data management utility 203 that is operated under the OS 201 via the OS 201. The OD data management utility 203 is set as a resident program (that is synchronously booted when the computer 10 is started up).

When receiving the above notification, the OD data management utility requests the OS 201 to load the SATA host controller driver 202 used to permit the OS 201 to control the SATA host controller in the chipset 102 that controls access to the ODD 105. Then, the OD data management utility 203 requests the OS 201 to cause the ODD 105 to eject a tray. When completing loading of the SATA host controller driver 202, the OS 201 controls the SATA host controller in the chipset 201 via the SATA host controller driver 202 to cause the ODD 105 to eject the tray.

When the tray of the ODD 105 is ejected from the tray ejection port 106, the user places a storage medium including audiovisual content stored thereon on the tray and loads the same into the ODD 105. Loading of the storage medium is notified to the chipset 102 from the ODD 105 and is further notified to the OD data management utility 203 as in the case wherein the ODD eject switch 161 is operated.

The OD data management utility 203 that has received the notification checks the type of data on the storage medium loaded into the ODD 105 and determines whether or not the storage medium is used to store audiovisual content to be reproduced by the audiovisual reproduction software 204. Then, if the storage medium is used to store audiovisual content to be reproduced by the audiovisual reproduction software 204, the OD data management utility 203 automatically starts the caching operation of the audiovisual content by means of the SSD 104 without waiting for the reproduction operation for the audiovisual content by the user, more specifically, an access operation with respect to the ODD 105 by means of the audiovisual reproduction software 204.

In the computer 10, an OD data caching area “b” used to cache audiovisual content on the storage medium loaded into the ODD 105 is provided separately from a user usable area in the storage area of the SSD 104. For example, the presence of the OD data caching area “b” is concealed from the user by using storage capacity obtained by subtracting the storage capacity of the OD data caching area “b” from the actual storage capacity of the SSD 104 as the storage capacity of the SSD 104 to set up a configuration. When the notification of loading of the storage medium is given to the OD data management utility 203, it caches all of the audiovisual content on the storage medium in the OD data caching area “b” of the SSD 104.

When the above caching operation is completed, the OD data management utility 203 requests the OS 201 to unload the SATA host controller driver 202 and notifies an instruction of interrupting supply of power to the ODD 105 to the EC/KBC 106. The EC/KBC 106 de-asserts an ODD power-on signal to the load switch “a” to interrupt supply of power to the ODD 105.

Further, the OD data management utility 203 requests the OS 201 to set up a configuration used to recognize the OD data caching area “b” of the SSD 104 in which all of the audiovisual content is cached as one independent storage device (different from the SSD 104), more specifically, as the ODD 105. As a result, when the user actually wants to enjoy audiovisual content on a storage medium by means of the audiovisual reproduction software 204 after the storage medium is loaded into the ODD 105, access to the SSD 104 is made instead of access to the ODD 105 and the silencing and power saving operation can be realized.

Next, the operation of the computer 10 when the user ejects a storage medium on which audiovisual content is stored from the ODD 105 is explained.

When the ODD eject switch 161 is operated (to eject the storage medium from the ODD 105), the operation is also detected by the EC/KBC 106. The EC/KBC 106 asserts an ODD power-on signal with respect to the load switch “a” to start supply of power to the ODD 105 and notify power-on of the ODD 105 to the chipset 102 via the LPC bus. Subsequently, as described before, the operation of the ODD eject switch 161 is transmitted from the chipset 102 to the OD data management utility 203 and the operation of loading the SATA host controller driver 202 is performed.

At this time, the OD data management utility 203 checks whether or not audiovisual content is cached in the OD data caching area “b” of the SSD 104. If the audiovisual content is cached, the OD data management utility 203 erases all of the audiovisual content cached in the OD data caching area “b” of the SSD 104. After completion of the erase operation, the OD data management utility 203 requests the OS 201 to cause the ODD 105 to eject the tray. The erase operation is not a logical erase operation to erase data on a system file, for example, but is a physical erase operation to cause the SSD 104 to initialize the corresponding portion.

As a result, the audiovisual content is cached in a period in which the storage medium is loaded in the ODD 105 and the rule of protection by copyright is maintained. Further, when the cached audiovisual content is erased, the OD data management utility 203 requests the OS 201 to set a configuration in which the OD data caching area “b” of the SSD 104 is recognized as the ODD 105 back to an original state in which the OD data caching area “b” is concealed (as if the power source of the ODD 105 is turned off or isolated).

In order to clarify the explanation, in the explanation for the operation of the computer 10 when the user loads a storage medium on which audiovisual content is stored into the ODD 105, whether the audiovisual content obtained when the ODD eject switch 161 is operated is cached or not is not explained. However, when the operation of the ODD eject switch 161 is notified to the OD data management utility 203, it checks whether the audiovisual content is cached or not for each time.

That is, the OD data management utility 203 does not pay any attention to whether the operation is an operation of the ODD eject switch 161 to load the storage medium into the ODD 105 or an operation of the ODD eject switch 161 to eject the storage medium from the ODD 105. For example, when an operation of the ODD eject switch 161 is performed to exchange storage media (to eject a storage medium before exchange and load a storage medium after exchange), the presence of audiovisual content stored on the storage medium after exchange and cached in the OD data caching area “b” of the SSD 104 is checked at this timing and the audiovisual content is erased.

In other words, the audiovisual content cached in the OD data caching area “b” of the SSD 104 is kept stored on the SSD 104 (that is a nonvolatile storage apparatus) even if the power source of the computer 10 is turned off or shifted to a power saving state such as a suspend or standby state until the ODD eject switch 161 is operated.

Therefore, in a case where the power source of the computer 10 is turned off or shifted to a power saving state such as a suspend or standby state while the storage medium is not ejected from the ODD 105 and is kept loaded therein, reproduction by means of the audiovisual reproduction software 204 can be restarted by using the audiovisual content on the SSD 104 without newly caching the audiovisual content on the storage medium when the power source is turned on or restored from the power saving state later.

When the storage medium loaded into the ODD 105 does not store audiovisual content to be reproduced by means of the audiovisual reproduction software 204, the OD data management utility 203 does not perform the operations of (i) caching data in the OD data caching area “b” of the SSD 104, (ii) setting up a configuration to recognize the OD data caching area “b” of the SSD 104 as the ODD 105 and (iii) turning off the power source of the ODD 105.

Therefore, it makes access to the storage medium by use of an application program other than the audiovisual reproduction software 204 via the ODD 105 as in the usual case. Further, when the ODD eject switch 161 is operated to eject the storage medium, the power source of the ODD 105 is set in the ON state and the SATA host control driver 202 is set in the loaded state. However, the EC/KBC 106 and OD data management utility 203 mechanically act on requests of asserting an ODD power-on signal to the load switch “a” and loading the SATA host controller driver 202 to the OS 201 according to a preset procedure without paying any attention to the above condition.

The load switch “a” only maintains the power supply state with respect to the ODD 105 without causing any problem even if the ODD power-on signal is successively asserted. Further, the OS 201 only issues a response of completion of loading without causing any problem even if loading of the loaded program is requested. That is, in the computer 10, when a storage medium that does not store audiovisual content to be reproduced by the audiovisual reproduction software 204 is loaded into or ejected from the ODD 105, the power source of the ODD 105 is turned on at timing at which the ODD switch 161 is operated to load the storage medium into the ODD 105. After this, the power source of the ODD 105 is turned OFF at timing at which the ODD switch 161 is operated to eject the storage medium from the ODD 105.

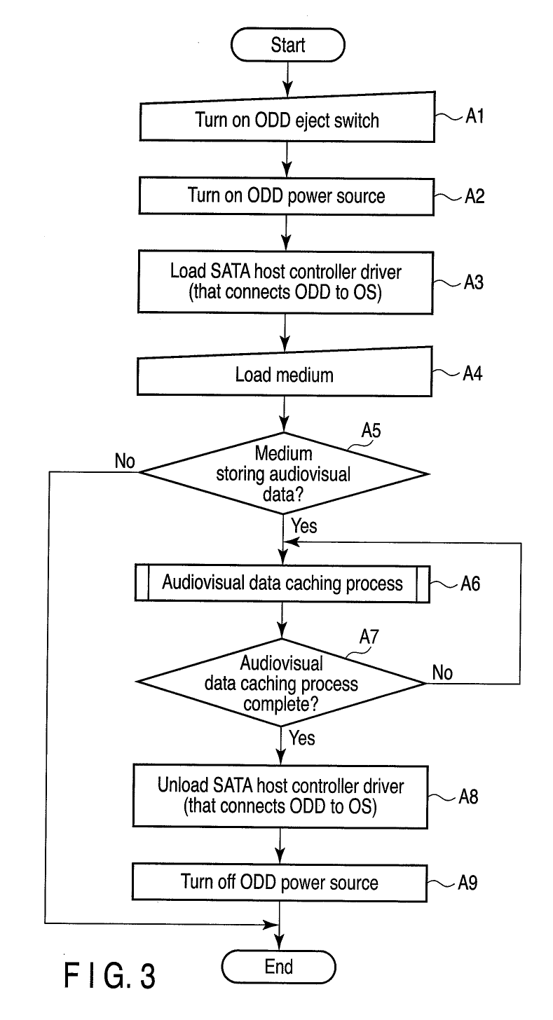

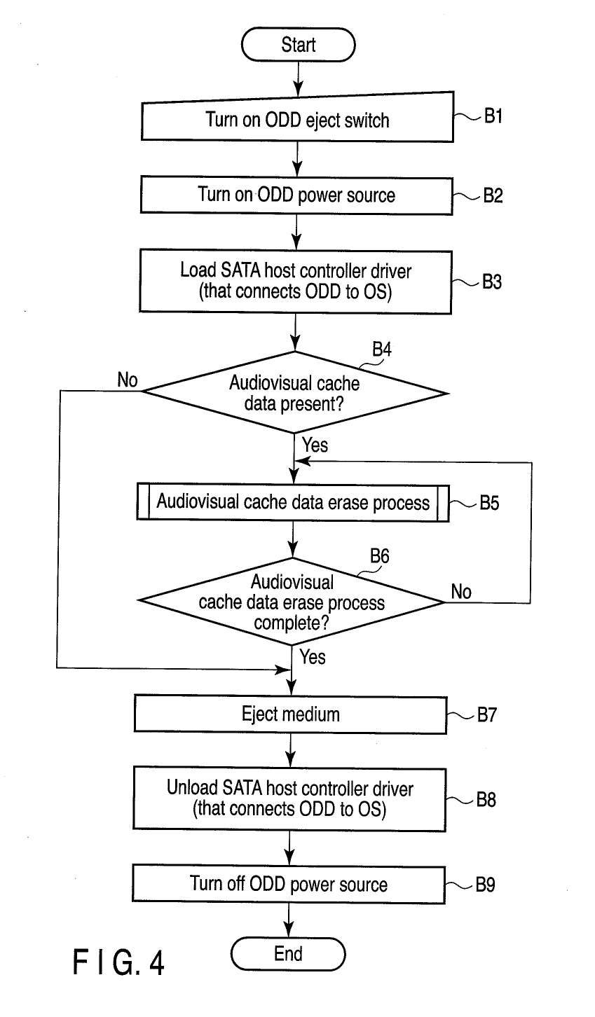

FIG. 3 and FIG. 4 are flowcharts for illustrating the flows of audiovisual content caching processes executed by the computer 10. FIG. 3 illustrates the flow of the caching process when a storage medium on which audiovisual content is stored is loaded into the ODD 105 and FIG. 4 illustrates the flow of the caching process when a storage medium on which audiovisual content is stored is ejected from the ODD 105.

When the ODD eject switch 161 is operated (to load the storage medium into the ODD 105) (block A1), the EC/KBC 106 turns on the power source of the ODD 105 (block A2) and the OD data management utility 203 loads the SATA host controller driver 202 (block A3).

Then, if the storage medium is loaded into the ODD 105 (block A4), the OD data management utility 203 determines whether or not the storage medium stores audiovisual content to be reproduced by the audiovisual reproduction software 204 (block A5). If the storage medium stores audiovisual content to be reproduced by the audiovisual reproduction software 204 (YES in block A5), the OD data management utility 203 automatically performs a process of caching all of the audiovisual content in the OD data caching area “b” of the SSD 104 (block A6).

Subsequently, when the caching process is completed (YES in block A7), the OD data management utility 203 unloads the SATA host controller driver 202 (block A8) and the EC/KBC 106 (that is specified by the OD data management utility 203) turns off the power source of the ODD 105 (block A9).

On the other hand, when the ODD eject switch 161 is operated (to eject the storage medium from the ODD 105) (block B1), the EC/KBC 106 turns on the power source of the ODD 105 (block B2) and the OD data management utility 203 loads the SATA host controller driver 202 (block B3).

Then, the OD data management utility 203 determines whether or not audiovisual content is cached in the OD data caching area “b” of the SSD 104 (block B4). If the audiovisual content is cached (YES in block B4), the computer causes the ODD 105 to perform a process of erasing all of the cached audiovisual content (block B5).

If the audiovisual content is not cached in the OD data caching area “b” of the SSD 104 (NO in block B4) or if the cached data erasing process is completed (YES in block B6), the OD data management utility 203 causes the ODD 105 to eject the tray, that is, eject the storage medium (block B7) and unload the SATA host controller driver 202 (block B8). Further, the EC/KBC 106 (that is specified by the OD data management utility 203) turns OFF the power source of the ODD 105 (block B9).

As described above, in the computer 10, when the storage medium on which audiovisual content is stored is loaded into the ODD 105, the operation of caching the audiovisual content in the SSD 104 is automatically performed. Then, after completion of the above operation, supply of power to the ODD 105 is interrupted and access to the SSD 104 is made instead of access to the ODD 105 and the silencing and power saving operation can be realized. Further, since the audiovisual content cached in the SSD 104 is erased when the storage medium is ejected from the ODD 105, the rule of protection by copyright is maintained.

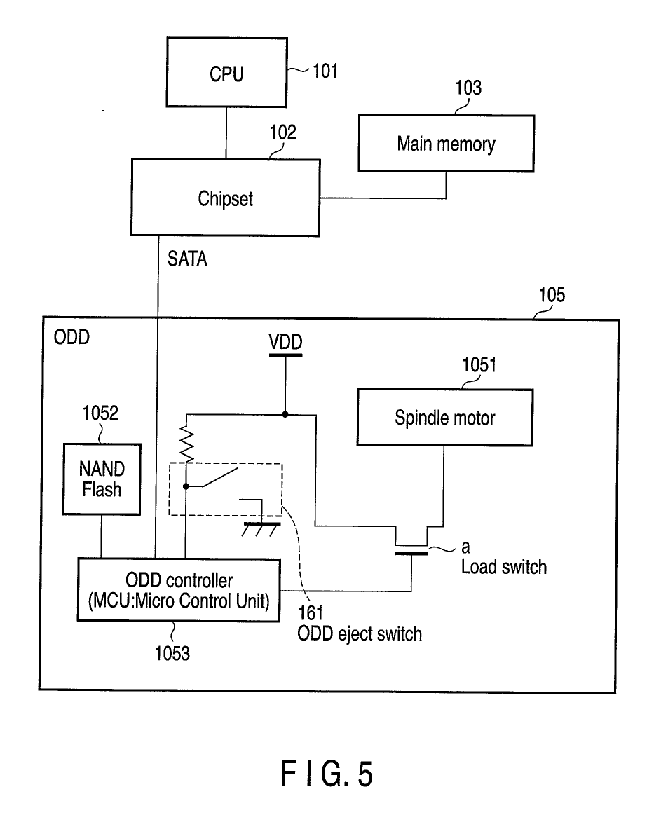

In the above explanation, an example wherein the audiovisual content caching management method is realized on the system main body side of the computer 10, more specifically, by means of the OD data management utility 203 executed by the CPU 101 is shown. However, the audiovisual content caching management method can be modified to be realized on the ODD 105 side. FIG. 5 is an exemplary diagram showing one configuration example of an ODD 105 provided with an audiovisual content caching management method.

As shown in FIG. 5, the ODD 105 includes a spindle a motor 1051, an NAND flash memory 1052, an ODD controller 1053 and the like. The ODD controller 1053 includes a function of detecting that the ODD eject switch 161 is operated and a function of performing a control operation to switch the power supply/interruption states of the spindle motor 1051. When detecting that the ODD eject switch 161 is operated, the ODD controller 1053 asserts an ODD power-on signal to the load switch “a” and starts supply of power to the spindle motor 1051.

At this time, if data cached in the NAND flash memory 1052 is present, the ODD controller 1052 erases the cached data and then ejects the tray. After this, if a storage medium is loaded, the ODD controller 1053 automatically starts an operation of caching entire data stored on the storage medium in the NAND flash memory 1052. Then, after termination of the caching operation, the ODD controller 1053 de-asserts an ODD power-on signal to the load switch “a” and interrupts supply of power to the spindle motor 1051.

As a result, access to the storage medium via the chipset 102 can be entirely replaced by access to the NAND flash memory 1052. Further, since a state in which the spindle motor 1051 is stopped can be maintained, the silencing and power saving operation can be realized with the above configuration. In addition, since caching data is erased at the storage medium ejection time, the rule of protection by copyright is maintained.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a media drive configured to removably receive a storage medium;
a memory device configured to cache moving image data from the storage medium;
a controller configured to supply power to the media drive, the controller comprising a detector configured to detect whether the storage medium is loaded in the media drive or whether the storage medium is ejected from the media drive; and
a caching management module configured to manage caching of the moving image data in the memory device,
wherein the caching management module comprises
a first caching processing module configured to initiate caching of the moving image data from the storage medium in the memory device when the detector of the controller detects that the storage medium is loaded in the media drive; and
a second caching processing module configured to erase the cached moving image data in the memory device when the detector of the controller detects that the storage medium is ejected from the media drive.

2. The apparatus of claim 1, wherein the first caching processing module is configured to issue a command of interrupting power supply to the media drive to the controller after the moving image data is cached in the memory device.

3. The apparatus of claim 1, wherein the second caching processing module is configured to issue a command of ejecting the storage medium from the media drive after the cached moving image data are erased.

4. The apparatus of claim 1, wherein the memory device comprises an electrically programmable nonvolatile semiconductor memory.

5. The apparatus of claim 4, further comprising:
a power saving function of temporarily interrupting an operation and saving a state at an interrupted time in a restorable manner; and
a state management module configured to maintain a state where the moving image data in the storage medium are cached in the memory device if the power saving function is performed while the storage medium is in the media drive.

6. The apparatus of claim 4, further comprising a state management module configured to maintain a state where the moving image data in the storage medium are cached in the memory device if a power-off operation is performed while the storage medium is in the media drive.

7. The apparatus of claim 1, further comprising an operation module that is operated to selectively perform either operations of loading a storage medium into the media drive or ejecting a storage medium from the media drive,
wherein the controller is configured to start power supply to the media drive when the operation module is operated.

8. A media drive comprising:
a tray configured to removably receive a storage medium;
a memory device configured to cache data in the storage medium received by the tray;
an operation module configured to eject the tray; and
a caching management module configured to manage a caching of the data in the memory device,
wherein the caching management module comprises:
a first caching processing module configured to initiate caching of the data from the storage medium in the memory device when the storage medium is received by the tray; and
a second caching processing module configured to erase the cached data in the memory device if the operation module is operated while the storage medium is received.

9. A medium data caching management method of an information processing apparatus that comprises a media drive configured to removably receive a storage medium, a memory device configured to cache moving image data in the storage medium and a controller configured to supply a power to the media drive and to detect that the storage medium is loaded in the media drive and that the storage medium is ejected from the media drive, the method comprising:
initiating caching moving image data from the storage medium in the memory device when the controller detects that the storage medium is loaded in the media drive; and
erasing the cached moving image data in the memory device when the controller detects that the storage medium is ejected from the media drive.

10. The method of claim 9, further comprising issuing a command of interrupting power supply to the media drive to the controller after the moving image data is cached in the memory device.

11. The method of claim 9, further comprising issuing a command of ejecting the storage medium to the media drive after the cached moving image data are erased.
